(19) United States
(12) Patent Application Publication
(10) Pub. No.: US 2026/0012782 A1
(43) Pub. Date: Jan. 8, 2026

(54) SYSTEM AND METHOD FOR COMMUNICATION

(71) Applicant: JIO PLATFORMS LIMITED, Ahmedabad (IN)

(72) Inventors: Aayush BHATNAGAR, Navi Mumbai (IN); Aarthi MUTHUPANDI, Kalyan West (IN); Amit Kumar SINGH, Kalyan East (IN); Arun DEWNA, Jaipur (IN)

(73) Assignee: JIO PLATFORMS LIMITED, Ahmedabad (IN)

(21) Appl. No.: 18/992,918

(22) PCT Filed: May 10, 2024
(86) PCT No.: PCT/IN2024/050513

§ 371 Date: Jan. 9, 2025

(30) Foreign Application Priority Data
Jun. 27, 2023 (IN) 202321043156

(51) Int. Cl. H04W 8/28; H04W 4/14

(52) U.S. Cl. CPC H04W 8/28; H04W 4/14

(57) ABSTRACT

The present disclosure 5 related to a method (1000) for communication. The method (1000) comprising initiating (1002) at least one request message towards a short message service centre SMSC (212), receiving (1004) the at least one request message by the SMSC (212) and forwarding (1006) the at least one request message towards a mobile number portability unique porting code gateway (MNPUPCGW) 10 (202). The method (1000) comprising determining (1008) a mobile station integrated services digital network (MSISDN) range of the UE (204) based on the received at least one request message. The method (1000) comprising performing (1010) at least one query in a database (210) to select at least one mobile number portability clearing house (MCH) belonging to the determined MSISDN range, and 15 routing (1012) the received at least one request message to the at least one selected MCH over the SMPP interface and receiving (1014) the at least one request message.

### RESERVATION OF RIGHTS

A portion of the disclosure of this patent document contains material which is subject to intellectual property rights such as, but are not limited to, copyright, design, trademark, integrated circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to a field of Mobile Number Portability (MNP), and specifically to a system and a method for communication.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Conventional methods and systems involve complex procedure which consumes several days (may take 7 days to complete a Mobile Number Portability (MNP) porting process). Furthermore, the existing Short Message Service Centre (SMSC) do not have the functionally to selectively route the SMS over a Short Message Peer to Peer (SMPP) basis A-Party MSISDN.

In conventional system architecture (100), as depicted in FIG. 1, since MCH is not maintaining a mesh connection with MNP-UPC-Gateway (MNP-UPC-GW) (110), in case of link failure with any MCH instance, 1900 messages destined to it through that UPCGW instance gets failed. Furthermore, the MCH vendors associated in the system lacks the capacity to enhance the system and caters the requirement. Hence, the need evolved to design a new architecture with an internal communication link between two active gateways.

Further, in the conventional methods and systems, if the primary (Primary UPCGW) goes down, the MCH may be informed, and manual activation of the bind may be done by the MCH towards a disaster recovery (DR) UPCGW. Also, manual activation of the binds may be done by DR UPCGW towards Application to Person (A2P) SMSC. If the Primary MNP Clearing House (PR MCH) goes down, the MCH may switch to Disaster recovery MNP Clearing House (DR MCH) and manually activate the binds with the PR/DR UPCGW. If MCH instance 1 (S1) goes down, UPCGW instance 1 (S1) may not refrain from receiving SMPP traffic from the SMSC. Instead, incoming traffic from SMSC may be tried to MCH instance 2 (S2) through UPCGW instance 2 (S2) (through internal communication between UPCGW S1 and UPCGW S2). If UPCGW S1 goes down, all incoming and outgoing traffic may be handled through UPCGW S2 until UPCGW S1 is restored back. For this duration, MCH may confirm the handling of incoming and outgoing traffic through the single UPCGW S2, which leads to link failure and fails to deliver the messages.

There is, therefore, a need in the art to improve state of communication by overcoming the deficiencies of the prior arts.

### Definition

As used in the present disclosure, the following terms are generally intended to have the meaning as set forth below, except to the extent that the context in which they are used to indicate otherwise.

The term UPC as used herein, refers to unique porting code. The UPC consists of 8 characters of which the first two characters specifies the service provider's name and service area code.

The term MCH as used herein, refers to a mobile number portability clearing house (MCH). When a user/subscriber sends a request for porting the phone number, it is passed on to the MCH. The MCH in turn, passes the request to an existing operator (also known as donor operator).

The term MSISDN as used herein, refers to a mobile station international subscriber directory number. The MSISDN is a unique identifier assigned to each mobile device in a global system for mobile communications (GSM) network. The MSISDN links the subscriber and their mobile device and the network.

The term SMSC as used herein, refers to a short message service center. The SMSC is a portion of a mobile phone network that handles text message operations. It is responsible for receiving, storing, routing and forwarding SMS messages from mobile handsets.

The term CLI as used herein, refers to a command-line interface. The CLI is a text-based interface where you can input commands that interact with a computer's operating system. The CLI operates with the help of the default shell, which is between the operating system and the user.

The term SMPP as used herein, refers to short message peer-to-peer protocol. The SMPP is a telecommunications industry protocol for exchanging SMS messages over the internet.

### OBJECTS OF THE PRESENT DISCLOSURE

It is an object of the present disclosure to deploy a Mobile Number Portability (MNP) Unique Porting Code Gateway (UPCGW) to maintain complete Mobile Station Integrated Services Digital Network (MSISDN) ranges and map the MSISDN to Short Message Peer to Peer (SMPP) account basis respective region served by given MNP Clearing House (MCH).

It is an object of the present disclosure to provide MNP UPCGW to receive UPC request Short Message Service (SMS) (to 1900) from whole Short Message Service Centres (SMSCs) over the SMPP and lookup in its MSISDN Database (DB).

It is an object of the present disclosure to route the same SMS to the MCH again over the SMPP interface.

It is an object of the present disclosure to provide an enhanced method for MNP.

It is an object of the present disclosure to provide a system and method for providing ease of services to the associated users for porting the mobile number.

It is an object of the present disclosure to optimize the communication system.

It is an object of the present disclosure to provide an internal communication mechanism between at least two MNP gateways in an active mode.

### SUMMARY

In an exemplary embodiment, the present invention discloses a method for communication. The method comprising initiating, by a user equipment (UE), at least one request message towards a short message service centre (SMSC). The method comprising receiving the at least one request message by the SMSC. The method comprising forwarding, by the SMSC, the at least one request message towards a mobile number portability unique porting code gateway (MNPUPCGW) over a short message peer to peer (SMPP) interface. The method comprising determining a mobile station integrated services digital network (MSISDN) range of the UE based on the received at least one request message. The method comprising performing, by the MNPUPCGW, at least one query in a database to select at least one mobile number portability clearing house (MCH) belonging to the determined MSISDN range. The method comprising routing the received at least one request message to the at least one selected MCH over the SMPP interface. The method comprising receiving, by the at least one selected MCH, the at least one request message.

In some embodiments, the method further comprising sending, to the SMSC, at least one negative response message when the identified MSISDN range does not belong to at least one MCH.

In some embodiments, the at least one negative response message comprises of at least one report message or an alarm message.

In some embodiments, the at least one MCH is associated with at least one SMPP account.

In some embodiments, the MNPUPCGW maps a plurality of available MSISDN ranges in the database with the at least one SMPP account of the at least one MCH based on a respective geographical region served by the at least one MCH.

In some embodiments, the at least one request message is a mobile number porting request message or a mobile number porting cancellation request message.

In some embodiments, the at least one request message is received from an internet protocol short message gateway (IPSMGW) when the UE is attached to a 4G network.

In some embodiments, the at least one request message is received from a short message service function (SMSF) when the UE is attached to a 5G network.

In some embodiments, the method further comprising generating, by the at least one selected MCH, a unique porting code (UPC) after receiving the at least one request message.

In some embodiments, the at least one selected MCH sends the generated UPC code to the MNPUPCGW.

In some embodiments, the MNPUPCGW sends the received UPC code towards the SMSC.

In some embodiments, the at least one request message is delivered to the at least one selected MCH through a first instance.

In some embodiments, the at least one request message is replicated to a second instance when the first instance fails to deliver the at least one request message to the at least one selected MCH.

In some embodiments, the MNPUPCGW is deployed by using an active-active model that includes providing at least one internal communication channel between at least two active instances through a replication and clustering (RPC) framework.

In some embodiments, the RPC framework includes forming at least one logical cluster of a plurality of active instances using a client server architecture.

In an exemplary embodiment, the present invention discloses a system for communication. The system is configured to initiate, by a user equipment (UE), at least one request message towards a short message service centre (SMSC). The system is configured to receive the at least one request message by the SMSC. The system is configured to forward, by the SMSC, the at least one request message towards a mobile number portability unique porting code gateway (MNPUPCGW) over a short message peer to peer (SMPP) interface. The system is configured to determine a mobile station integrated services digital network (MSISDN) range of the UE based on the received at least one request message. The system is configured to perform, by the MNPUPCGW, at least one query in a database to select at least one mobile number portability clearing house (MCH) belonging to the determined MSISDN range. The system is configured to route the received at least one request message to the at least one selected MCH over the SMPP interface. The system is configured to receive, by the at least one selected MCH, the at least one request message.

In some embodiments, the system is configured to send, to the SMSC, at least one negative response message when the identified MSISDN range does not belong to at least one MCH.

In some embodiments, the at least one negative response message comprises of at least one report message or an alarm message.

In some embodiments, the at least one MCH is associated with at least one SMPP account.

In some embodiments, the MNPUPCGW maps a plurality of available MSISDN ranges in the database with the at least one SMPP account of the at least one MCH based on a respective geographical region served by the at least one MCH.

In some embodiments, the at least one request message is a mobile number porting request message or a mobile number porting cancellation request message.

In some embodiments, the at least one request message is received from an internet protocol short message gateway (IPSMGW) when the UE is attached to a 4G network.

In some embodiments, the at least one request message is received from a short message service function (SMSF) when the UE is attached to a 5G network.

In some embodiments, the system is configured to generate, by the at least one selected MCH, a unique porting code (UPC) after receiving the at least one request message.

In some embodiments, the at least one selected MCH sends the generated UPC code to the MNPUPCGW.

In some embodiments, the MNPUPCGW sends the received UPC code towards the SMSC.

In some embodiments, the at least one request message is delivered to the at least one selected MCH through a first instance.

In some embodiments, the at least one request message is replicated to a second instance when the first instance fails to deliver the at least one request message to the at least one selected MCH.

In some embodiments, the MNPUPCGW is deployed by using an active-active model that includes providing at least one internal communication channel between at least two active instances through a replication and clustering (RPC) framework.

In some embodiments, the RPC framework includes forming at least one logical cluster of a plurality of active instances using a client server architecture.

In an exemplary embodiment, the present invention discloses a user equipment (UE) attached to a network for communication. The UE comprising a transceiver, a processor, and a memory unit including computer code that when executed causes the processor to initiate at least one request message towards the network and receive at least one response message from the network. The network is configured to receive the at least one request message by a short message service centre SMSC. The network is configured to forward, by the SMSC, the at least one request message towards a mobile number portability unique porting code gateway (MNPUPCGW) over a short message peer to peer (SMPP) interface. The network is configured to determine a mobile station integrated services digital network (MSISDN) range of the UE based on the received at least one request message. The network is configured to perform, by the MNPUPCGW, at least one query in a database to select at least one mobile number portability clearing house (MCH) belonging to the determined MSISDN range. The network is configured to route the received at least one request message to the at least one selected MCH over the SMPP interface. The network is configured to receive, by the at least one selected MCH, the at least one request message.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates an exemplary architecture of an active model in a Mobile Number Portability (MNP)-Unique Porting Code (UPC)-gateway (GW), in accordance with the prior arts.

FIG. 2 illustrates an exemplary network architecture in which or with which embodiments of the present disclosure may be implemented.

FIG. 3 illustrates an exemplary architecture of an active model in an MNP-UPC-GW (202), in accordance with an embodiment of the present disclosure.

FIG. 4 illustrates an exemplary sequential diagram of internal communication channel between two active instances through replication and clustering (RPC), in accordance with an embodiment of the present disclosure.

FIG. 5 illustrates an exemplary flow diagram of the MNP-UPCGW system operation, in accordance with an embodiment of the present disclosure.

FIG. 6 illustrates an exemplary flow chart of port out message flow, in accordance with an embodiment of the present disclosure.

FIG. 7 illustrates an exemplary flow chart of UPC notification flow, in accordance with an embodiment of the present disclosure.

FIG. 8 illustrates an exemplary flow chart of message replication flow, in accordance with an embodiment of the present disclosure.

FIG. 9 illustrates an exemplary computer system in which or with which embodiments of the present disclosure may be implemented.

FIG. 10 illustrates an exemplary flow diagram for a method for communication, in accordance with an embodiment of the present disclosure.

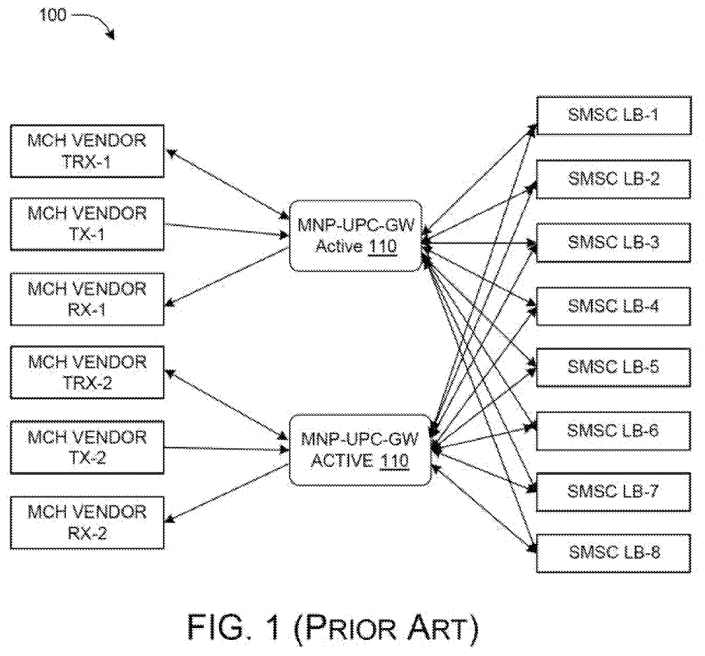

### LIST OF REFERENCE NUMERALS

100—Network architecture
110, 202, 508—Mobile Number Portability (MNP)-Unique Porting Code (UPC)-gateway (GW)
200—Network architecture
204—User equipment (UE)
206—Network
208—Command line interface (CLI)
210—Database
212, 401, 506—A short message service centre (SMSC)
300—Network architecture
400—Flow diagram
402, 403—MNPUPCGW instance
404, 510—Mobile number portability clearing house (MCH)
500—Flow diagram
502—Subscriber
600—Flow diagram
700—Flow diagram
800—Flow diagram
900—A computer system
910—External storage device
920—Bus
930—Main memory
940—Read only memory
950—Mass storage device
960—Communication port(s)
970—Processor
1000—Flow diagram

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

At present, a length of existing Mobile Number Portability (MNP) porting process is curtailed from 7 days to 2 days. As a part of this change, a Unique Porting Code (UPC) may be generated by a MNP Clearing House (MCH) instead of a donor operator. The donor operator is defined as the operator in whose network the ported number had been before the port has taken place. Thus, the donor operator is a cellular mobile service provider providing service to the subscriber before porting. In such case, basis A-Party Mobile Station Integrated Services Digital Network (MSISDN), the donor operator needs to route an UPC request Short Message Service (SMS) to respective MCH. The existing Short Message Service Centre (SMSC) do not have the functionally to selectively route the SMS over a Short Message Peer to Peer (SMPP) basis A-Party MSISDN.

The present disclosure may deploy a (MNP) Unique Porting Code Gateway (UPCGW) to maintain complete MSISDN ranges and map the MSISDN to Short Message Peer to Peer (SMPP) account basis respective region served by given MCH. The present disclosure may provide MNP UPCGW to receive UPC request SMS (to 1900) from whole SMSCs over the SMPP and lookup in its MSISDN Database (DB). The present disclosure may efficiently route the same SMS to the MCH again over the SMPP interface.

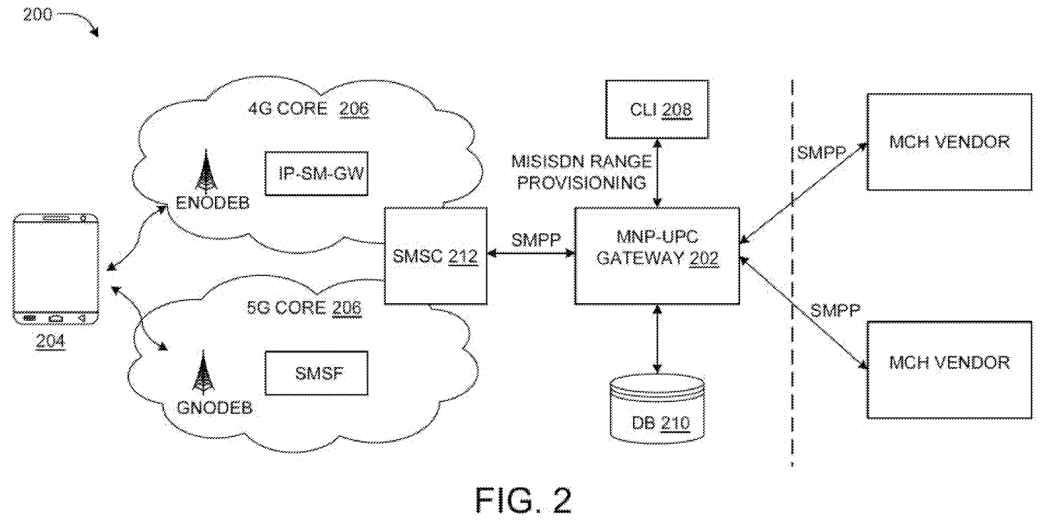

The various embodiments of the present disclosure will be explained in detail with reference to FIGS. 2 to 9.

FIG. 2 illustrates an exemplary network architecture (200) in which or with which embodiments of the present disclosure may be implemented.

Referring to FIG. 2, the network architecture (200) may be integrated with an MNP-UPC-GW (202). The MNP-UPC-GW (202) may act as a gateway/front interface to MCHs. The integration of the MNP-UPC gateway (202) may be directly done using a SMSC for port related activities.

In an embodiment, a subscriber (204) may be attached to either Fourth-Generation (4G) or Fifth-Generation (5G) network (206). The subscriber (204) may include one or more user equipments (204-1, 204-2 . . . 204-N) associated with one or more users in an environment. A person of ordinary skill in the art will understand that one or more users may be individually referred to as the user and collectively referred to as the users. Similarly, a person of ordinary skill in the art will understand that one or more user equipments (204-1, 204-2 . . . 204-N) may be individually referred to as the user equipment (204) and collectively referred to as the user equipment (204). A person of ordinary skill in the art will appreciate that the terms “computing device(s)” and “user equipment” may be used interchangeably throughout the disclosure.

In an embodiment, the user equipment (204) may include smart devices operating in a smart environment, for example, an Internet of Things (IoT) system. In such an embodiment, the user equipment (204) may include, but is not limited to, smart phones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for the users and/or entities, or any combination thereof. A person of ordinary skill in the art will appreciate that the user equipment may include, but is not limited to, intelligent, multi-sensing, network-connected devices, that can integrate seamlessly with each other and/or with a central server or a cloud-computing system or any other device that is network-connected.

In an embodiment, the user equipment (204) may include, but is not limited to, a handheld wireless communication device (e.g., a mobile phone, a smart phone, a phablet device, and so on), a wearable computer device(e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the user equipment (204) may include, but is not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the user equipment (204) may include one or more in-built or externally coupled accessories including, but not limited to, a visual aid device such as a camera, an audio aid, a microphone, a keyboard, and input devices for receiving input from the user or the entity such as touch pad, touch enabled screen, electronic pen, and the like. A person of ordinary skill in the art will appreciate that the user equipment (204) may not be restricted to the mentioned devices and various other devices may be used.

In an embodiment, the network (206) may enable the subscriber (204) to communicate with other devices in the network architecture (200). The network (206) may include a wireless card or some other transceiver connection to facilitate this communication. In another embodiment, the network (206) may be implemented as, or include any of a variety of different communication technologies such as a wide area network (WAN), a local area network (LAN), a wireless network, a mobile network, a Virtual Private Network (VPN), the Internet, the Public Switched Telephone Network (PSTN), or the like.

In an embodiment, MSISDN range provisioning may be done via a pre-loaded excel sheet at start up and runtime addition/deletion and similar Move, Add, Change or Delete/Disconnection (MACD) operations may be done through an application Command-Line Interface (CLI) (208). This data may be then stored in cache and a Database (DB) (210).

In an embodiment, the subscriber (204) may initiate an SMS to 1900 (short code) for porting out. In case the subscriber (204) is attached to 4G, SMS may be received from an Internet Protocol Short Message Gateway (IPSMGW) and may be forwarded to the MNP-UPC-GW (202) by a serving SMSC (212) over a SMPP. In case the subscriber (204) is attached to 5G, SMS may be received from a Short Message Service Function (SMSF) and may be forwarded to the MNP-UPC-GW (202) by the serving SMSC (212) on the SMPP.

On receipt of the SMS, the MNP-UPC-GW (202) may perform a DB query to lookup whether an A-Party MSISDN belongs to MCH vendor. Based on the series, the MNP-UPC-GW (202) may route the SMS to MCH vendor over a SMPP account.

In an embodiment, the MNP-UPC-GW (202) may perform the following functions: port out message flow, UPC notification flow, and replication case flow.

Although FIG. 2 shows exemplary components of the network architecture (200), in other embodiments, the network architecture (200) may include fewer components, different components, differently arranged components, or additional functional components than depicted in FIG. 2. Additionally, or alternatively, one or more components of the network architecture (200) may perform functions described as being performed by one or more other components of the network architecture (200).

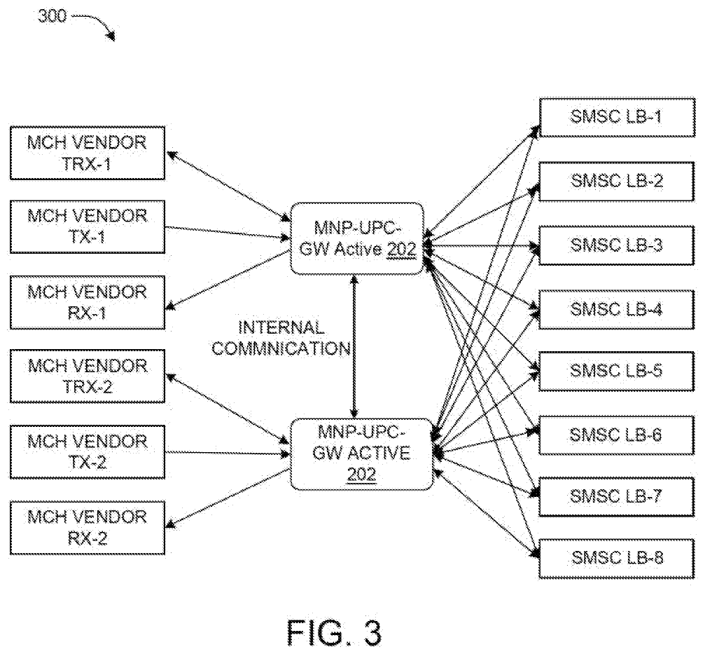

FIG. 3 illustrates an exemplary architecture (300) of an active model in an MNP-UPC-GW (202), in accordance with an embodiment of the present disclosure.

With respect to FIG. 3, the MNP-UPC-GW (202) may be deployed to maintain whole MSISDN ranges and map the MSISDN to MCH vendor SMPP account basis respective region served by a given MCH. The MNP-UPC-GW (202) may receive UPC request SMS (to 1900) from SMSCs over a SMPP and lookup in its MSISDN DB. The MNP-UPC-GW (202) may route the same SMS to the MCH again over a SMPP interface. The SMPP interface is a standard protocol in telecom industry standards that is used for message exchange between a message centre (MC) and an external short messaging entities (ESME's) or routing entities. The SMPP protocol is put to use by establishing a SMPP session which is based on transmission control protocol (TCP)/internet protocol (IP) suite between the MC and the ESMEs. The SMPP protocol is standardized and maintained by the SMPP developers forum with versions v3.4 and v5.0 as widely accepted in the open market.

Further, the SMPP account is a terminology used at MNP_UPC_GW to associate a MCH vendor with a SMPP session. The SMPP account comprises of a System_id, System_password, System_type, Bind_type, CSM handling, Allowed session count as the relevant parameters. The SMPP account detail is configured at MNP_UPC_GW and used while onboarding the ESME (e.g., MCH vendor). Further, the SMPP session needs to be authenticated prior to exchange of messages. The authentication is ensured using a combination of the System_id and System password, Bind type and Allowed sessions count. All these parameters constitute a SMPP account and MNP_UPC_GW maintains a separate account for each MCH vendor to ensure segregation. The relevant parameters are defined below:

System ID—The system identifier (ID) is a unique ID assigned for the ESME and may be used by the MC to authenticate the ESME requesting to bind.

System password—The system password may be used by the MC to authenticate the ESME requesting to bind.

Bind type—An ESME may bind to the MC as either a transmitter (called ESME transmitter), a receiver (called ESME receiver) or a transceiver (called ESME Transceiver).

System type—This parameter is used to categorize the type of ESME binding to the MC.

CSM handling—This parameter depicts the mechanism that MNP_UPC_GW will apply while dealing with concatenated (long) messages for a particular ESME. The supported mechanisms are SAR_TLV (tag length value) and UDH (user data header).

Allowed session count—This parameter denotes the maximum number of connections that the MNP_UPC_GW will allow per MCH vendor.

In an embodiment, the MNP-UPC-GW (202) may support the functionality as mentioned below:
1. The MNP-UPC-GW (202) may support SMPP interface in a server as well as in a client mode.
2. The MNP-UPC-GW (202) may be able to maintain a database of all MSISDN ranges allocated till date for all operators along with corresponding MCH SMPP account mapping.
3. The MNP-UPC-GW (202) may support SMPP 3.4v with backward compatibility.
4. The MNP-UPC-GW (202) may support any new version of SMPP as a part of roadmap requirement.
5. The MNP-UPC-GW (202) may have a support to receive a dump of entire MSISDN to MCH SMPP account mapping table in Comma-Separated Values (CSV) format.
6. The MNP-UPC-GW (202) may have a suitable interface for operations team to add/delete/modify the given MSISDN range/SMPP account.
7. The MNP-UPC-GW (202) may support bulk modify option to make changes of SMPP account for multiple MSISDN ranges.
8. The MNP-UPC-GW (202) may be able to generate report/alarm for any A-Party MSISDN range mapping if missing in database table for a given UPC request.
9. The MNP-UPC-GW (202) may be able to generate all standard reports.
10. For a single SMPP account, the MNP-UPC-GW (202) may support multiple sessions.
11. The MNP-UPC-GW (202) may support multiple IPs for the given SMPP account.
12. The MNP-UPC-GW (202) may support auto failover to standby IP in case of failure of primary IP for a given SMPP client/server.
13. The MNP-UPC-GW (202) may support delivery report for SMPP messages.
14. The MNP-UPC-GW (202) may be able to connect to multiple SMSCs over SMPP.
15. The MNP-UPC-GW (202) may have a capacity of 20 TPS.
16. The MNP-UPC-GW (202) may not have any single point of failure at hardware as well as software architecture level.
17. The MNP-UPC-GW (202) may be hardware agnostic and work efficiently on below server/alike configuration:
   a. Make—HP DL380/BL460 G6/G8
   b. Core—8core CPU
   c. HDD—900×2
   d. RAM—128 GB
   e. OS—Linux preferable
18. The MNP-UPC-GW (202) may support Simple Network Management Protocol (SNMP) traps for Network Management System (NMS) integration.
19. The MNP-UPC-GW (202) may support operations requirement for necessary integration with Operational Support System (OSS) elements like Privileged Identity Management (PIM), HP operations orchestration (HPOO), Granite, etc.

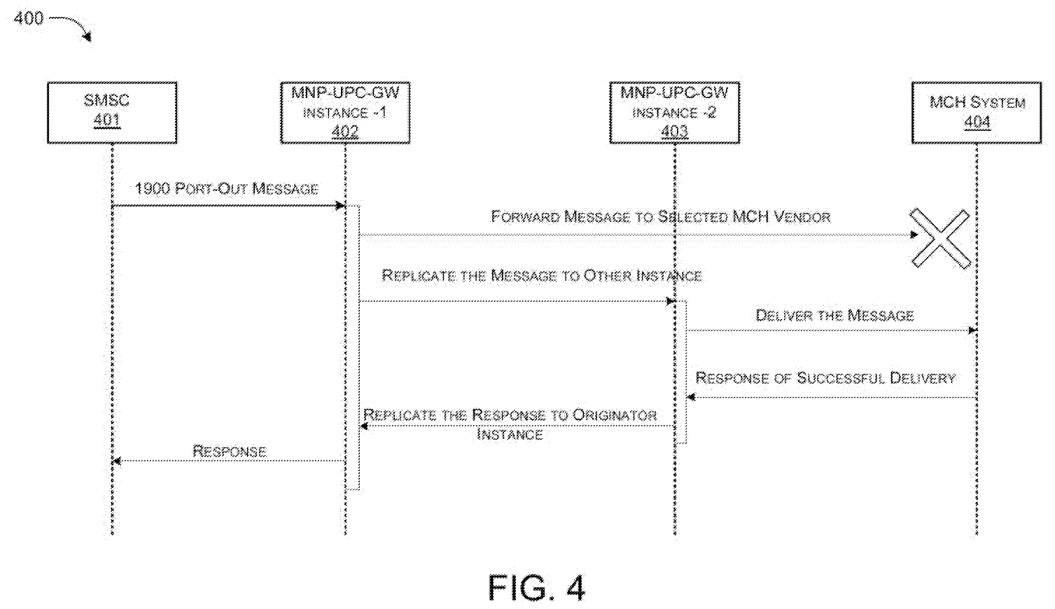

FIG. 4 illustrates an exemplary sequential diagram (400) of internal communication channel between two active instances through replication and clustering (RPC), in accordance with an embodiment of the present disclosure.

With respect to FIG. 4, an internal communication channel may be an interface between two active instances through the RPC. This interface may be designed internally. In an embodiment, the SMSC (401) sends a 1900 port out message to the MNPUPCGW instance (402). The MNPUPCGW instance (402) may unable to forward the 1900 port out message to the MCH system (404).

In an embodiment, internal communication may be enabled through a replication and clustering framework. In this, a logical cluster of active instances (402,403) may be formed with the help of client server architecture. Each instance (402) may be aware of its other instance (403) through configurations and when any of the instances (402,403) run first, one instance (402) may try to connect with the other configured instance (403). When one instance (402) is unable to connect with the other configured instance (403), the instance (403) may assume the role of server. The other instance (403) when run, may perform the same and may be able to establish a connection and becomes part of the cluster. The connection may enable all the data received by any one instance (403) to be replicated to other instance (403). However, in case of MNP-UPC-GW, replication happens only when one instance (402) of MNP-UPC-GW fails to deliver the message to a MCH vendor (404). As soon as other MNP-UPC-GW active instance (404) delivers the message to the MCH vendor (404), the response may be sent by following a complete path. The messages may be encoded before dispatching to other instance and similarly the messages may be decoded on recipient instance.

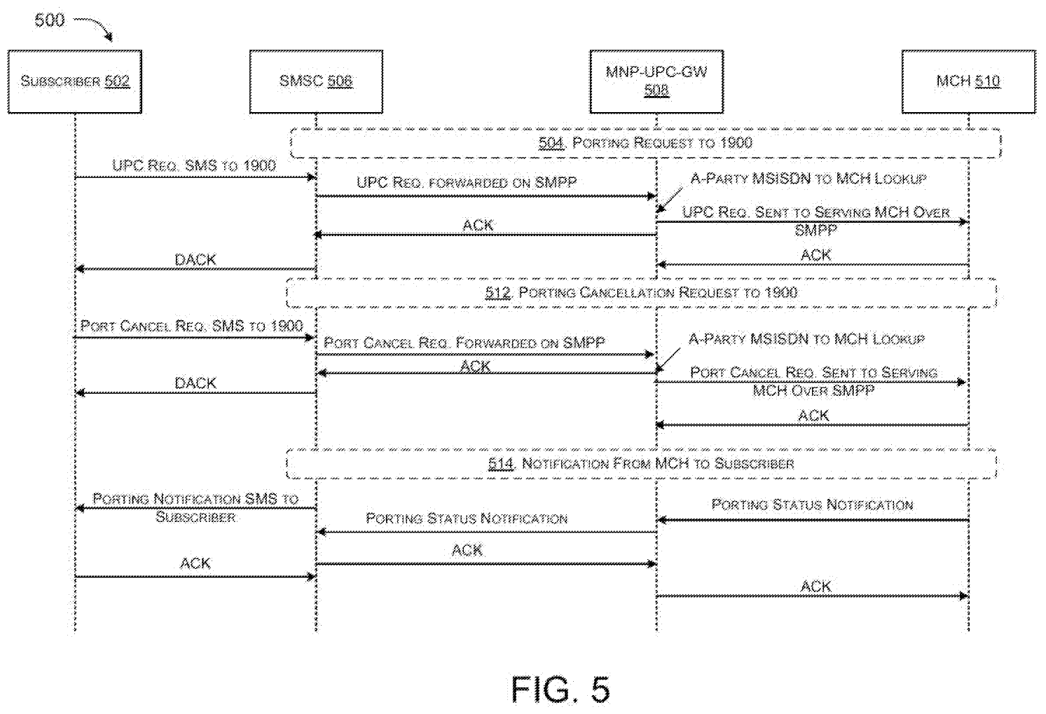

FIG. 5 illustrates an exemplary flow diagram (500) of the MNP-UPC-GW operation, in accordance with an embodiment of the present disclosure.

With respect to FIG. 5, the subscriber (502) may be attached to either 4G or 5G network. MSISDN range provisioning may be done via a pre-loaded excel sheet at start up and runtime addition/deletion and similar MACD operations may be done through an application CLI. The data may be stored in a cache and a DB.

The subscriber (502) may initiate an SMS to 1900 (short code) for porting out by sending a UPC request SMS to 1900, at 504.

In case the subscriber (502) is attached to 4G, the SMS may be received from IPSMGW and may be forwarded to the MNP-UPC-GW (508) by a serving SMSC (506) over a SMPP.

In case the subscriber is attached to 5G, the SMS may be received from SMSF and may be forwarded to the MNP-UPC-GW (508) by the serving SMSC (506) on the SMPP.

On receipt of the SMS, the MNP-UPC-GW (508) may perform a DB query to lookup whether the A-Party MSISDN belongs to MCH vendor.

Based on the series, the MNP-UPC-GW (508) may further route the SMS to MCH vendor over the SMPP account.

To cancel porting, a port cancel request SMS may be initiated by the subscriber (502) and forwarded to the MNP-UPC-GW (508) by the serving SMSC (506) on the SMPP, at 512. Further, the port cancel request SMS may be sent to a serving MCH (510) over the SMPP to cancel porting of messages.

At 514, the serving MCH (510) may send notifications corresponding to the porting status to the subscriber (502).

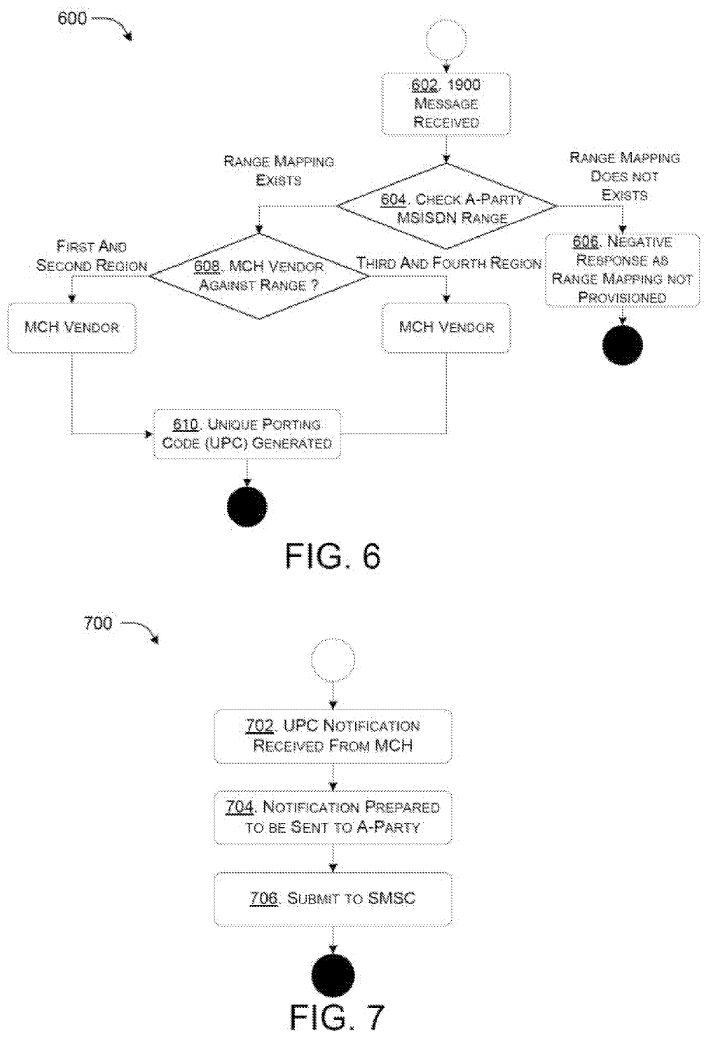

FIG. 6 illustrates an exemplary flow chart (600) of port out message flow, in accordance with an embodiment of the present disclosure.

With respect to FIG. 6, 1900 message may be received at the MNP-UPC-GW from the SMSC for porting out to a recipient operator, at 602. At 604, the MNP-UPC-GW may validate the subscriber's MSISDN range for MCH provisioning.

In case the MSISDN range is not provisioned, the 1900 message may fail and the MNP-UPC-GW may send negative response back to the SMSC, at 606.

In case MSISDN range is provisioned, the MNP-UPC-GW may perform query to fetch MCH vendor corresponding to the range, at 608.

If the MSISDN range of the subscriber belongs to a first region and a second region, a MCH vendor may be selected as the MCH vendor, and another MCH vendor may be selected if the range belongs to a third region and a fourth region.

Once the message is submitted to the MCH vendor, process for UPC generation may get initiated at their end, at 610.

FIG. 7 illustrates an exemplary flow chart (700) of UPC notification flow, in accordance with an embodiment of the present disclosure.

With respect to FIG. 7, once the UPC generation is initiated at 610, the UPC may be generated at the MCH end, and the MCH vendor may deliver the UPC in a form of notification message towards the MNP-UPC-GW, at 702.

At 704, the MNP-UPC-GW may prepare the notification which is to be delivered to the subscriber who had opted for the port-out.

At 706, the MNP-UPC-GW may deliver the notification to the SMSC.

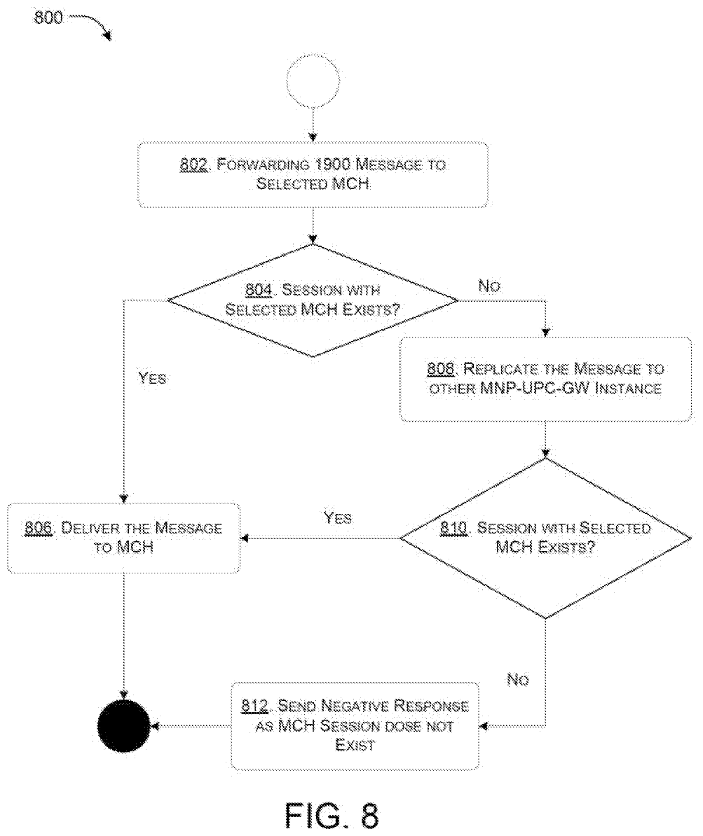

FIG. 8 illustrates an exemplary flow chart (800) of message replication flow, in accordance with an embodiment of the present disclosure.

With respect to FIG. 8, once the MCH vendor is selected as per the subscriber's MSISDN range and the 1900 message is forwarded to the selected MCH vendor at 802, the MNP-UPC-GW may check for existence of session with selected MCH vendor, at 804.

If session exists, the message may be delivered to that MCH vendor for further processing, at 806.

If session do not exist, the message may be replicated to other active MNP-UPC-GW for delivery attempt, at 808.

At 810, the MNP-UPC-GW may check for existence of session with selected MCH vendor. If the session with the selected MCH vendor exists, the message may be delivered to the selected MCH vendor for further processing, as at 806.

If the session does not exist even on that MNP-UPC-GW instance, then a negative response may be initiated and sent to the MCH vendor, at 812.

In an aspect, the present invention provides a system and method for providing ease of services to the associated users for porting the mobile number. In an aspect, the present invention provides an enhanced method for mobile number portability (MNP). In an aspect, the present invention can be implemented in 4G and 5G network architecture.

In an exemplary embodiment, the present invention discloses a method for communication. The method comprising initiating, by a user equipment (UE), at least one request message towards a short message service centre (SMSC). The method comprising receiving the at least one request message by the SMSC. The method comprising forwarding, by the SMSC, the at least one request message towards a mobile number portability unique porting code gateway (MNPUPCGW) over a short message peer to peer (SMPP) interface. The method comprising determining a mobile station integrated services digital network (MSISDN) range of the UE based on the received at least one request message. The method comprising performing, by the MNPUPCGW, at least one query in a database to select at least one mobile number portability clearing house (MCH) belonging to the determined MSISDN range. The method comprising routing the received at least one request message to the at least one selected MCH over the SMPP interface. The method comprising receiving, by the at least one selected MCH, the at least one request message.

In some embodiments, the method further comprising sending, to the SMSC, at least one negative response message when the identified MSISDN range does not belong to at least one MCH.

In some embodiments, the at least one negative response message comprises of at least one report message or an alarm message.

In some embodiments, the at least one MCH is associated with at least one SMPP account.

In some embodiments, the MNPUPCGW maps a plurality of available MSISDN ranges in the database with the at least one SMPP account of the at least one MCH based on a respective geographical region served by the at least one MCH.

In some embodiments, the at least one request message is a mobile number porting request message or a mobile number porting cancellation request message.

In some embodiments, the at least one request message is received from an internet protocol short message gateway (IPSMGW) when the UE is attached to a 4G network.

In some embodiments, the at least one request message is received from a short message service function (SMSF) when the UE is attached to a 5G network.

In some embodiments, the method further comprising generating, by the at least one selected MCH, a unique porting code (UPC) after receiving the at least one request message.

In some embodiments, the at least one selected MCH sends the generated UPC code to the MNPUPCGW.

In some embodiments, the MNPUPCGW sends the received UPC code towards the SMSC.

In some embodiments, the at least one request message is delivered to the at least one selected MCH through a first instance.

In some embodiments, the at least one request message is replicated to a second instance when the first instance fails to deliver the at least one request message to the at least one selected MCH.

In some embodiments, the MNPUPCGW is deployed by using an active-active model that includes providing at least one internal communication channel between at least two active instances through a replication and clustering (RPC) framework.

In some embodiments, the RPC framework includes forming at least one logical cluster of a plurality of active instances using a client server architecture.

In an exemplary embodiment, the present invention discloses a system for communication. The system is configured to initiate, by a user equipment (UE), at least one request message towards a short message service centre (SMSC). The system is configured to receive the at least one request message by the SMSC. The system is configured to forward, by the SMSC, the at least one request message towards a mobile number portability unique porting code gateway (MNPUPCGW) over a short message peer to peer (SMPP) interface. The system is configured to determine a mobile station integrated services digital network (MSISDN) range of the UE based on the received at least one request message. The system is configured to perform, by the MNPUPCGW, at least one query in a database to select at least one mobile number portability clearing house (MCH) belonging to the determined MSISDN range. The system is configured to route the received at least one request message to the at least one selected MCH over the SMPP interface. The system is configured to receive, by the at least one selected MCH, the at least one request message.

In an exemplary embodiment, the present invention discloses a user equipment (UE) attached to a network for communication. The UE comprising a transceiver, a processor, and a memory unit including computer code that when executed causes the processor to initiate at least one request message towards the network and receive at least one response message from the network. The network is configured to receive the at least one request message by a short message service centre SMSC. The network is configured to forward, by the SMSC, the at least one request message towards a mobile number portability unique porting code gateway (MNPUPCGW) over a short message peer to peer (SMPP) interface. The network is configured to determine a mobile station integrated services digital network (MSISDN) range of the UE based on the received at least one request message. The network is configured to perform, by the MNPUPCGW, at least one query in a database to select at least one mobile number portability clearing house (MCH) belonging to the determined MSISDN range. The network is configured to route the received at least one request message to the at least one selected MCH over the SMPP interface. The network is configured to receive, by the at least one selected MCH, the at least one request message.

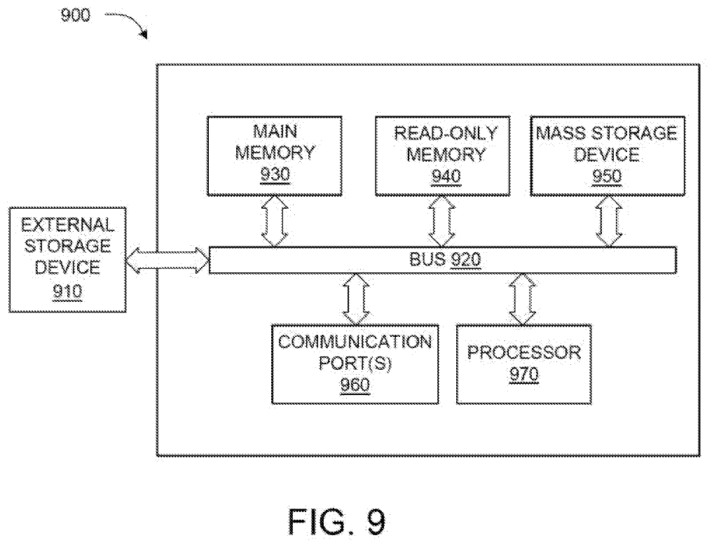

FIG. 9 illustrates an exemplary computer system (900) in which or with which embodiments of the present disclosure may be implemented.

As shown in FIG. 9, the computer system (900) may include an external storage device (910), a bus (920), a main memory (930), a read only memory (940), a mass storage device (950), a communication port (960), and a processor (970). A person skilled in the art will appreciate that the computer system (900) may include more than one processor (970) and communication ports (960). Processor (970) may include various modules associated with embodiments of the present disclosure.

In an embodiment, the communication port (960) may be any of an RS-232 port for use with a modem-based dialup connection, a 10/100 Ethernet port, a Gigabit or 10 Gigabit port using copper or fiber, a serial port, a parallel port, or other existing or future ports. The communication port (960) may be chosen depending on a network, such a Local Area Network (LAN), Wide Area Network (WAN), or any network to which the computer system (900) connects.

In an embodiment, the memory (930) may be Random Access Memory (RAM), or any other dynamic storage device commonly known in the art. Read-only memory (940) may be any static storage device(s) e.g., but not limited to, a Programmable Read Only Memory (PROM) chips for storing static information e.g., start-up or Basic Input/Output System (BIOS) instructions for the processor (970).

In an embodiment, the mass storage device (950) may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus (920) communicatively couples the processor(s) (970) with the other memory, storage and communication blocks. The bus (920) may be, e.g., a Peripheral Component Interconnect (PCI)/PCI Extended (PCI-X) bus, Small Computer System Interface (SCSI), Universal Serial Bus (USB) or the like, for connecting expansion cards, drives and other subsystems as well as other buses, such a front side bus (FSB), which connects the processor (970) to the computer system (900).

Optionally, operator and administrative interfaces, e.g., a display, keyboard, joystick, and a cursor control device, may also be coupled to the bus (920) to support direct operator interaction with the computer system (900). Other operator and administrative interfaces may be provided through network connections connected through the communication port (960). Components described above are meant only to exemplify various possibilities. In no way should the aforementioned exemplary computer system (900) limit the scope of the present disclosure.

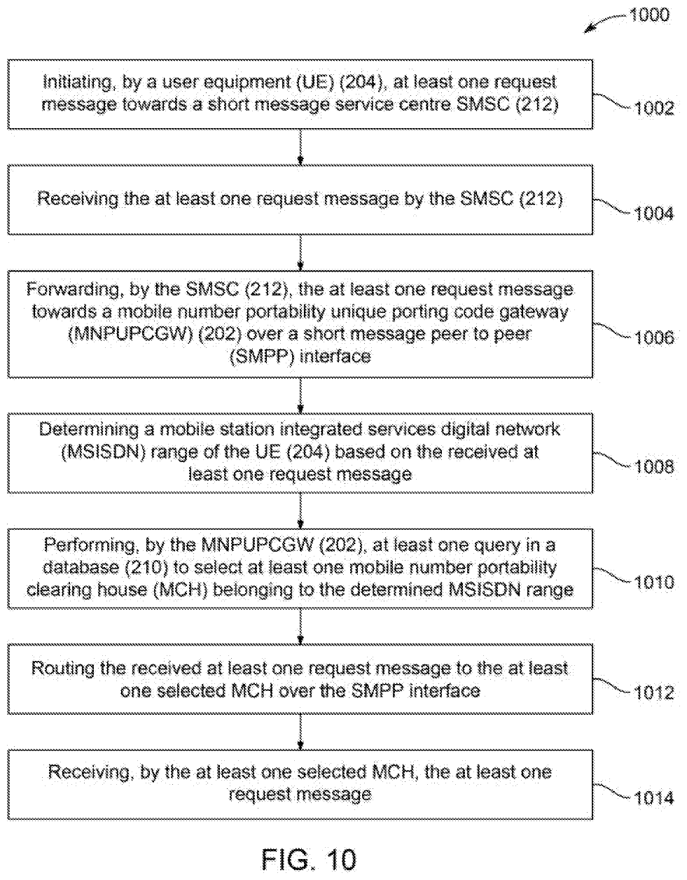

FIG. 10 illustrates an exemplary flow diagram for a method for communication, in accordance with an embodiment of the present disclosure.

At step 1002, the method comprising, initiating (1002), by a user equipment (UE) (204), at least one request message towards a short message service centre SMSC (212).

At step 1004, the method comprising, receiving (1004) the at least one request message by the SMSC (212).

At step 1006, the method comprising, forwarding (1006), by the SMSC (212), the at least one request message towards a mobile number portability unique porting code gateway (MNPUPCGW) (202) over a short message peer to peer (SMPP) interface.

At step 1008, the method comprising, determining (1008) a mobile station integrated services digital network (MSISDN) range of the UE (204) based on the received at least one request message.

At step 1010, the method comprising, performing (1010), by the MNPUPCGW (202), at least one query in a database (210) to select at least one mobile number portability clearing house (MCH) belonging to the determined MSISDN range.

At step 1012, the method comprising, routing (1012) the received at least one request message to the at least one selected MCH over the SMPP interface.

At step 1014, the method comprising, receiving (1014), by the at least one selected MCH, the at least one request message.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions or examples, which are included to enable a person having ordinary skill in the art to make and use the present disclosure when combined with information and knowledge available to the person having ordinary skill in the art.

### Advantages of the Present Disclosure

The present disclosure deploys a Mobile Number Portability (MNP) Unique Porting Code Gateway (UPCGW) to maintain complete Mobile Station Integrated Services Digital Network (MSISDN) ranges and map the MSISDN to Short Message Peer to Peer (SMPP) account basis respective region served by given MNP Clearing House (MCH).

The present disclosure provides MNP UPCGW to receive UPC request Short Message Service (SMS) (to 1900) from whole Short Message Service Centres (SMSCs) over the SMPP and lookup in its MSISDN Database (DB).

The present disclosure routes the same SMS to the MCH again over the SMPP interfaces.

1. A method for communication, the method comprising:
initiating, by a user equipment (UE), at least one request message towards a short message service centre SMSC;
receiving the at least one request message by the SMSC;
forwarding, by the SMSC, the at least one request message towards a mobile number portability unique porting code gateway (MNPUPCGW) over a short message peer to peer (SMPP) interface;
determining a mobile station integrated services digital network (MSISDN) range of the UE based on the received at least one request message;
performing, by the MNPUPCGW, at least one query in a database to select at least one mobile number portability clearing house (MCH) belonging to the determined MSISDN range;
routing the received at least one request message to the at least one selected MCH over the SMPP interface; and
receiving, by the at least one selected MCH, the at least one request message.

2. (canceled)

3. (canceled)

4. (canceled)

5. The method as claimed in claim 1, wherein the MNPUPCGW maps a plurality of available MSISDN ranges in the database with at least one SMPP account of the at least one selected MCH based on a respective geographical region served by the at least one selected MCH.

6. (canceled)

7. (canceled)

8. (canceled)

9. The method as claimed in claim 1, further comprising generating, by the at least one selected MCH, a unique porting code (UPC) after receiving the at least one request message.

10. The method as claimed in claim 1, wherein the at least one selected MCH sends the generated UPC code to the MNPUPCGW.

11. The method as claimed in claim 1, wherein the MNPUPCGW sends the received UPC code towards the SMSC.

12. The method as claimed in claim 1, wherein the at least one request message is delivered to the at least one selected MCH through a first instance.

13. The method as claimed in claim 1, wherein the at least one request message is replicated to a second instance when the first instance fails to deliver the at least one request message to the at least one selected MCH.

14. The method as claimed in claim 1, wherein the MNPUPCGW is deployed by using an active-active model that includes providing at least one internal communication channel between at least two active instances through a replication and clustering (RPC) framework.

15. The method as claimed in claim 1, wherein the RPC framework includes forming at least one logical cluster of a plurality of active instances using a client server architecture.

16. A system for communication, the system is configured to:
initiate, by a user equipment (UE), at least one request message towards a short message service centre SMSC;
receive the at least one request message by the SMSC;
forward, by the SMSC, the at least one request message towards a mobile number portability unique porting code gateway (MNPUPCGW) over a short message peer to peer (SMPP) interface;
determine a mobile station integrated services digital network (MSISDN) range of the UE based on the received at least one request message;
perform, by the MNPUPCGW, at least one query in a database to select at least one mobile number portability clearing house (MCH) belonging to the determined MSISDN range;
route the received at least one request message to the at least one selected MCH over the SMPP interface; and
receive, by the at least one selected MCH, the at least one request message.

17. (canceled)

18. (canceled)

19. (canceled)

20. The system as claimed in claim 16, wherein the MNPUPCGW maps a plurality of available MSISDN ranges in the database with at least one SMPP account of the at least one selected MCH based on a respective geographical region served by the at least one selected MCH.

21. (canceled)

22. (canceled)

23. (canceled)

24. The system as claimed in claim 16, further configured to generate, by the at least one selected MCH, a unique porting code (UPC) after receiving the at least one request message.

25. The system as claimed in claim 16, wherein the at least one selected MCH sends the generated UPC code to the MNPUPCGW.

26. The system as claimed in claim 16, wherein the MNPUPCGW sends the received UPC code towards the SMSC.

27. The system as claimed in claim 16, wherein the at least one request message is delivered to the at least one selected MCH through a first instance.

28. The system as claimed in claim 16, wherein the at least one request message is replicated to a second instance when the first instance fails to deliver the at least one request message to the at least one selected MCH.

29. The system as claimed in claim 16, wherein the MNPUPCGW is deployed by using an active-active model that includes providing at least one internal communication channel between at least two active instances through a replication and clustering (RPC) framework.

30. The system as claimed in claim 16, wherein the RPC framework includes forming at least one logical cluster of a plurality of active instances using a client server architecture.

31. A user equipment (UE) attached to a network for communication, the UE comprising a transceiver, a processor, and a memory unit including computer code that when executed causes the processor to:
initiate at least one request message towards the network; and
receive at least one response message from the network;
wherein the network is configured to:
receive the at least one request message by a short message service centre SMSC;
forward, by the SMSC, the at least one request message towards a mobile number portability unique porting code gateway (MNPUPCGW) over a short message peer to peer (SMPP) interface;
determine a mobile station integrated services digital network (MSISDN) range of the UE based on the received at least one request message;
perform, by the MNPUPCGW, at least one query in a database to select at least one mobile number portability clearing house (MCH) belonging to the determined MSISDN range;
route the received at least one request message to the at least one selected MCH over the SMPP interface; and
receive, by the at least one selected MCH, the at least one request message.

32. A computer program product comprising a non-transitory computer-readable medium comprising instructions that, when executed by one or more processors, cause the one or more processors to perform a method for communication, the method comprising:
initiating, by a user equipment (UE), at least one request message towards a short message service centre SMSC;
receiving the at least one request message by the SMSC;
forwarding, by the SMSC, the at least one request message towards a mobile number portability unique porting code gateway (MNPUPCGW) over a short message peer to peer (SMPP) interface;
determining a mobile station integrated services digital network (MSISDN) range of the UE based on the received at least one request message;
performing, by the MNPUPCGW, at least one query in a database to select at least one mobile number portability clearing house (MCH) belonging to the determined MSISDN range;
routing the received at least one request message to the at least one selected MCH over the SMPP interface; and
receiving, by the at least one selected MCH, the at least one request message.
